(19) United States
(12) Patent Application Publication
(10) Pub. No.: US 2008/0192492 A1
(43) Pub. Date: Aug. 14, 2008

(54) Lighting Assembly for a Sunshade or an Awning

(76) Inventor: Nengsen Chen, Zhejiang (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/029,362

(22) Filed: Feb. 11, 2008

(30) Foreign Application Priority Data
Feb. 14, 2007 (CN) 200720106586.5

(51) Int. Cl. F21V 21/116; F21V 17/00

(52) U.S. Cl. 362/368; 362/362

(57) ABSTRACT

A lighting assembly includes a first unit and a second unit. The first unit defines an inner recess which has an inner end surface. The second unit is shaped to fit within the inner recess of the first unit. The second unit has an inner surface. The first unit and the second unit are removeably engaged, and the inner end surface of the first unit and the inner surface of the second unit form an opening when the first unit and the second unit are engaged. The first unit has one or more openings for receiving one or more light units.

### TECHNICAL FIELD

The present disclosure relates to a lighting assembly for a sunshade or an awning, and more particularly, to a lighting assembly which may be removably and adjustably attached to a pole of the sunshade or the awning.

### BACKGROUND

Sunshades or awnings are commonly used in many places, such as beach areas, patio areas, campsites or domestic gardens, etc. A conventional sunshade or awing usually includes a base, a supporting pole upwardly extended therefrom, a foldable awning frame which includes a plurality of awning supporting arms radically and outwardly extending from an upper portion of the supporting pole, and a fabric awning securely and foldably mounted on the awning supporting arms.

When the sunshade or awning is used at night, it may be desirable to have a lighting attached to the sunshade or awning for the purpose of illuminating a night-time function or activity. Some conventional lighting assemblies for sunshades or awnings have been developed. For example, a decorative string of Christmas lights used outdoors may be attached to a sunshade or awning on its supporting pole or supporting arms, and may be powered by an AC power supply of 220V or 110V. The conventional lighting units may include several disadvantages. For example, outdoor sunshades or awnings need to be folded and unfolded frequently, and therefore, the conventional lighting units may be easily damaged if kept in a folded sunshade or awning. In addition, a user may want to adjust the position of the lighting units to a different desired position after they are attached to the sunshade or awning. It may be difficult to adjust the position of the conventional lighting units once they are attached to the sunshade or awning. Moreover, some campgrounds or beach area may not provide any power source for providing electricity to the light. Even though there are power sources in such places, it may be inconvenient for the user to extend an electrical cord from the lighting units to the power source.

The disclosed system is directed to overcoming one or more of the problems set forth above.

### SUMMARY OF THE INVENTION

In one aspect, the present disclosure is direct to a lighting assembly. The lighting assembly may include a first unit and a second unit. The first unit may define an inner recess which may have an inner end surface. The second unit may be shaped to fit within the inner recess of the first unit. The second unit may have an inner surface. The first unit and the second unit may be removeably engaged. The inner end surface of the first unit and the inner surface of the second unit may form an opening when the first unit and the second unit are engaged. The first unit may have one or more openings for receiving one or more light units.

In another aspect, the present disclosure is direct to a lighting assembly. The lighting assembly may include a first housing and a second housing. The first housing may define an inner recess which may have an inner end surface. The second housing may be shaped to fit into the inner recess of the first housing. The second housing may have an inner surface. The first housing and the second housing may be removeably engaged. The inner end surface of the first housing and the inner surface of the second housing may form an opening for receiving a pole when the first housing and the second housing are engaged. A width of the inner recess may be sufficiently large to receive the pole radially and inwardly into the inner recess. The first housing may have one or more openings for receiving one or more light units.

According to yet another aspect, the present disclosure is directed to a lighting assembly. The lighting assembly may include a first housing and a second housing. The first housing may define an inner recess which may have an inner end surface. The first housing may also include a leading screw extending radially within the first housing. The leading screw may have outer screw threads. At least a portion of the inner end surface may be moveable and may include an elongated hole with inner screw threads for engaging with the outer screw threads of the leading screw. The second housing may be shaped to fit the inner recess of the first housing. The second housing may have an inner surface. The first housing and the second housing may be removeably engaged, and the inner end surface of the first housing and the inner surface of the second housing may form an opening for receiving a pole when the first housing and the second housing are engaged. The first housing may have one or more openings for receiving one or more light units.

### BRIEF DESCRIPTION OF THE DRAWINGS

FIG. 1 is a schematic view of an exemplary embodiment of the disclosed lighting assembly;

FIG. 2 is a bottom perspective view of the disclosed lighting assembly;

FIG. 3 is a top view of the disclosed lighting assembly; and

FIG. 4 is a cross-sectional view taken along line A-A shown in FIG. 3.

### DETAILED DESCRIPTION

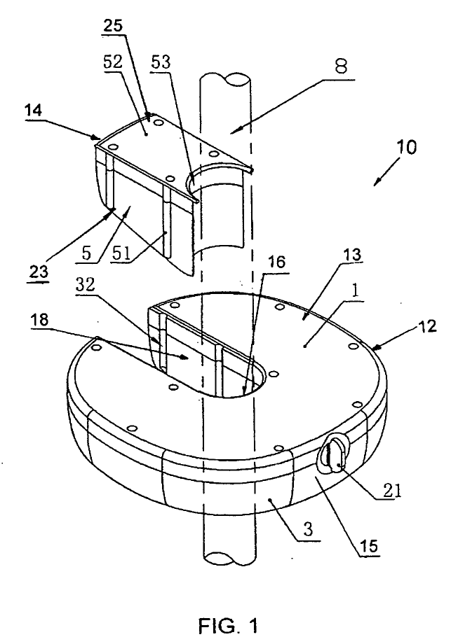

FIG. 1 illustrates an exemplary lighting assembly 10. The lighting assembly 10 may include a first unit 12 and a second unit 14. The first unit 12 may have a substantially U-shape, C-shape, or other shapes, with an inner cut or recess extending radially. The second unit 14 may have a shape that fits within the inner cut or recess in the first unit 12. The first unit 12 may include a housing 3 and a cover 1 attached to the housing 3. The first unit 12 may include an upper surface 13 on the top of the cover 1, a lower surface 15, a curved or round (e.g., substantially semi-cylindrical) inner end surface 16, and inner side surfaces 18 extending radially and outwardly from the round inner end surface 16. In one embodiment, a width between the two inner side surfaces 18 of the inner recess is sufficiently large, so that a pole 8 of a sunshade or awning can be received radially and inwardly into the inner recess. The second unit 14 may include a housing 23 and a cover 25 attached to the housing 23. In some exemplary embodiments, the second unit 14 may be made as an integrated piece. The second unit 14 may include an upper surface 52 on the top of the cover 25, a curved or round (e.g., substantially semi-cylindrical) inner surface 53 at one end of the second unit 14 and two side surfaces 5.

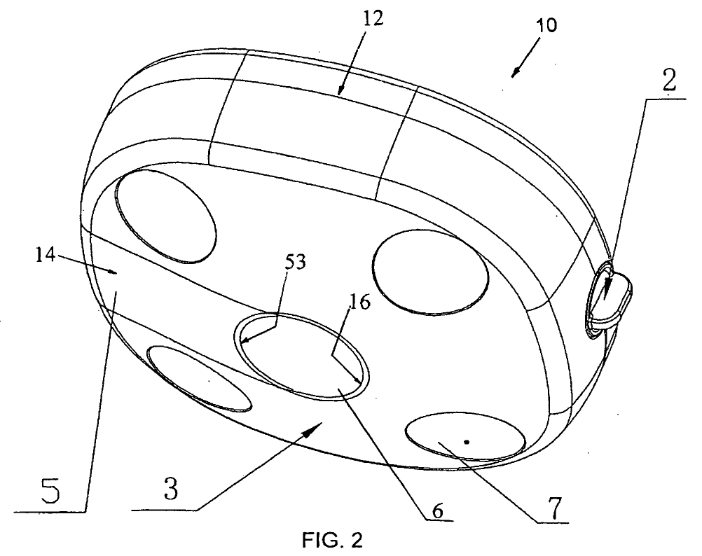

In some exemplary embodiments, one or more concave grooves 32 may be formed on the inner side surfaces 18 of the first unit 12, and one or more convex ridges 51 may be formed on the side surfaces 5 of the second unit 14, so that the second unit 14 may be engaged with the first unit 12 through the concave grooves 32 and the convex ridges 51. In some other exemplary embodiments, one or more convex ridges may be formed on the inner side surfaces 18 of the first unit 12, and one or more concave grooves may be formed on the side surfaces 5 of the second unit 14, so that the second unit 14 may be engaged with the first unit 12 through the concave grooves and the convex ridges. The cover 25 of the second unit 14 may include extended edges that engage with recesses at the upper end of the inner cut or recess defined in the first unit 12, so that when the second unit 14 is fitted into the first unit 12, as shown in FIGS. 1 and 2, the second unit 14 will be secured with the first unit 12.

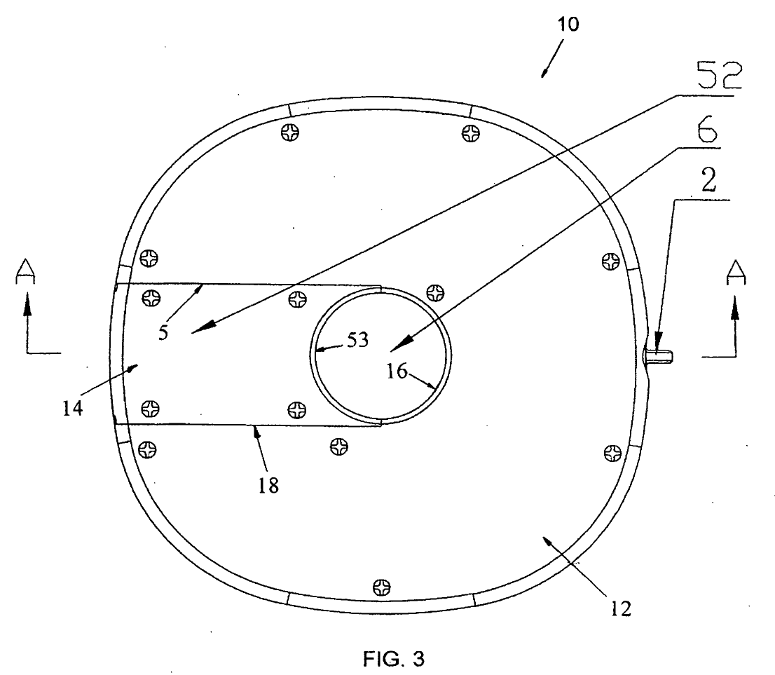

FIG. 2 shows a bottom perspective view of the lighting assembly 10, and FIG. 3 shows a top view of the lighting assembly 10. As shown in FIGS. 2 and 3, the second unit 14 may be engaged with the first unit 12 to form the lighting assembly 10 with a substantially round shape. The lighting assembly 10 may be embodied in any other suitable shapes, for example, an elliptical shape or a substantially rectangular shape. The inner end surface 16 of the first unit 12 and inner surface 53 of the second unit 14 may form an opening 6, which may have a substantially round shape. The opening 6 may be provided for fitting about the pole 8 (as shown in FIG. 1) of a sunshade or awning that the lighting assembly 10 is attached to. In some exemplary embodiments, the housing 3 of the first unit 12 may include one or more openings 7, which may include connections and/or fixtures for receiving one or more lighting units. For example, the openings 7 may include fixtures that may include inner screw threads for engaging outer screw threads of a lighting unit. In some exemplary embodiments, the first unit 12 may include one or more lighting units, for example, four lighting units within four openings 7, as shown in FIG. 2. In some exemplary embodiments, the lighting units may be LEDs.

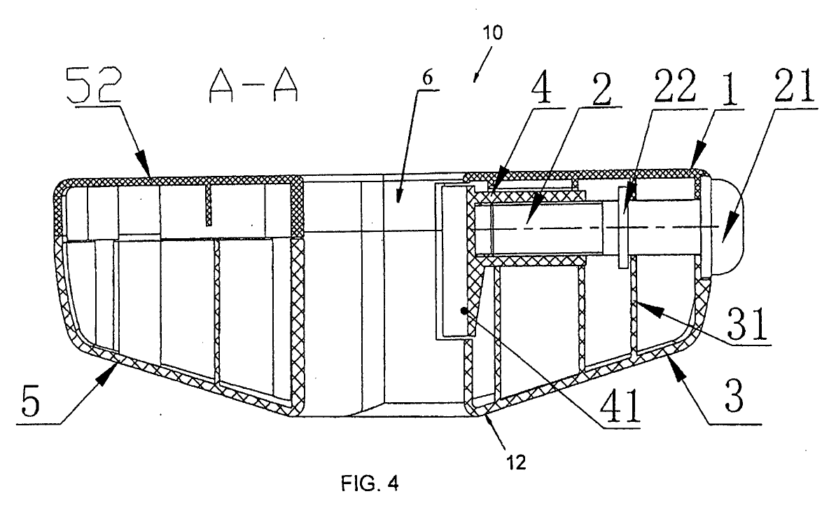

As shown in FIG. 4, the first unit 12 may include a leading screw 2 received in a passageway in the housing 3. The leading screw has a rotating handle 21 extending from a proximal end of the leading screw 2 to an outer wall of the housing 3. The leading screw 2 may pass through, and may be supported by, a throughhole formed on a baffle 31 in the housing 3. A stop plate 22 may extend radially and outwardly from the leading screw 2 as shown in FIG. 4. In use, the stop plate 22 may be engaged against an inner surface of the baffle 31, and that may prevent the leading screw 2 from moving radially and outwardly relative to the housing 3. The rotating handle 21 may engage against the outer wall of the housing 3, and that may prevent the leading screw 2 from moving radially and inwardly relative to the housing 3. When the rotating handle 21 is rotated, the leading screw 2 may be prevented from moving radially with respect to the housing 3.

The inner end surface 16 of the first unit 12 may include at least a portion 41 that is moveable relative to the first unit 12. The moveable portion 41 may include a driving block 4 extending radially from the inner end surface 16 to a proximal end. The moveable portion 41 may include a substantially semi-cylindrical distal end surface. The driving block 4 may define an elongated hole that may include inner screw threads on an inner surface of the elongated hole for engaging with the outer screw threads of the leading screw 2. Rotating the handle 21 of the leading screw 2 may drive the portion 41 of the inner end surface 16 back and forth. In use, when the pole 8 of a sunshade or awning is received in the hole 6, rotating the handle 21 may drive the portion 41 back or forth, and may secure the light assembly 10 on the pole 8 or release the lighting assembly 10 from the pole 8, and may allow the lighting assembly 10 to move along the pole 8.

In some exemplary embodiments, one or more batteries (e.g., rechargeable batteries) may be provided within the housing 3, and a power switch may be provided on a side wall of the housing 3. The design or arrangement for installing batteries in an open space within the housing 3 and a switch that controls the light units on a side wall of the housing 3 should be appreciated by a person skilled in the art.

The object of the present disclosure is to provide a lighting assembly. The lighting assembly may be easily attached to or removed from the pole of the sunshade or awning. Furthermore, the lighting assembly may be easily adjustable up or down to a desired position with respect to the pole. Moreover, the lighting assembly may be made with a damage-resistant material, for example, plastic or stainless steel, to make the lighting assembly durable. In addition, the lighting assembly may be powered by a battery, and thus, the lighting assembly can be used in some campgrounds or beach area where there may be no power source provided.

The lighting assembly may be locked on and fixed to the pole of the sunshade or awning at a desired position by rotating the leading screw. The arrangement allows the height of the lighting assembly with respect to the pole to be adjusted easily. The lighting assembly may also be detached from the pole easily and conveniently by separating the second unit from the first unit. The lighting assembly may use LEDs powered by low-voltage, rechargeable batteries. LEDs are safe and reliable, and difficult to break.

It will be apparent to those skilled in the art that various modifications and variations can be made in this lighting assembly without departing from the scope of this disclosure. Other embodiments of the disclosed lighting assembly will be apparent to those skilled in the art from consideration of the specification and practice of the lighting assembly disclosed herein. It is intended that the specification and embodiment be considered as exemplary only, with a true scope of the disclosure being indicated by the following claims and their equivalents.

What is claimed is:

1. A lighting assembly comprising:
a first unit defining an inner recess having an inner end surface;
a second unit shaped to fit within the inner recess of the first unit, said second unit having an inner surface,
wherein the first unit and the second unit are removeably engaged, and the inner end surface of the first unit and the inner surface of the second unit form an opening when the first unit and the second unit are engaged, and
wherein the first unit having one or more openings for receiving one or more light units.

2. The lighting assembly of claim 1, wherein the inner end surface of the inner recess has a substantially semi-cylindrical shape.

3. The lighting assembly of claim 1, wherein the inner surface of the second unit has a substantially semi-cylindrical shape.

4. The lighting assembly of claim 1, wherein the inner end surface of the first unit and the inner surface of the second unit form a substantially round opening when the first unit and the second unit are engaged.

5. The lighting assembly of claim 1, wherein the second unit includes a housing and a cover attached to the housing, and wherein the cover includes extended edges for engaging against upper edges of the inner recess of the first unit.

6. The lighting assembly of claim 1, wherein the first unit has a substantially U-shape.

7. The lighting assembly of claim 1, wherein the inner recess of the first unit is formed sufficiently large to receive a pole of a sunshade or awning radially and inwardly into the inner recess.

8. The lighting assembly of claim 1, wherein the inner recess of the first unit includes concave grooves on inner side surfaces of the first unit and the second unit includes convex ridges on side surfaces of the second unit for engaging the concave grooves of the first unit.

9. The lighting assembly of claim 1, wherein the inner recess of the first unit includes convex ridges on inner side surfaces of the first unit and the second unit includes concave grooves on side surfaces of the second unit for engaging the convex ridges of the first unit.

10. The lighting assembly of claim 1 further comprising a leading screw for adjusting the position of the lighting assembly with respect to a pole fitting through the opening of the lighting assembly.

11. The lighting assembly of claim 10 further comprising a rotating handle at a proximal end of the leading screw.

12. The lighting assembly of claim 11, wherein the rotating handle includes an inner surface for engaging against an outer wall of the first unit to prevent the leading screw from moving radially and inwardly relative to the first unit.

13. The lighting assembly of claim 10, wherein the inner end surface of the first unit includes at least one portion that is moveable relative to the first unit.

14. The lighting assembly of claim 13, wherein the moveable portion includes a driving block which defines an elongated hole, wherein the elongated hole includes inner screw threads for engaging with outer screw threads of the leading screw.

15. The lighting assembly of claim 13, wherein the moveable portion includes a substantially semi-cylindrical end surface.

16. The lighting assembly of claim 10, wherein the leading screw is supported by a throughhole formed on a baffle in the first unit, and the leading screw includes a stop plate for engaging against an inner side of the baffle to prevent the leading screw from moving radially and outwardly relative to the first unit.

17. A lighting assembly comprising:
a first housing having an inner recess including an inner end surface;
a second housing shaped to fit into the inner recess of the first housing, said second housing having an inner surface,
wherein the first housing and the second housing are removeably engaged, and the inner end surface of the first housing and the inner surface of the second housing form an opening for receiving a pole when the first housing and the second housing are engaged, and
wherein a width of the inner recess is sufficiently large to receive the pole radially and inwardly into the inner recess, and wherein the first housing having one or more openings for receiving one or more light units.

18. A lighting assembly of claim 17, wherein the inner end surface of the first housing includes at least a portion that is moveable relative to the first unit, the portion having an elongated hole with inner screw threads for engaging with screw threads of a leading screw received in the first housing for adjusting the position of the portion.

19. A lighting assembly comprising:
a first housing having an inner recess including an inner end surface, the first housing having a leading screw extending radially within the first housing, the leading screw having outer screw threads, wherein a portion of the inner end surface is moveable and includes an elongated hole with inner screw threads for engaging with outer screw threads of the leading screw;
a second housing shaped to fit within the inner recess of the first housing, said second housing having an inner surface,
wherein the first housing and the second housing are removeably engaged, and the inner end surface of the first housing and the inner surface of the second housing form an opening for receiving a pole when the first housing and the second housing are engaged, and
wherein the first housing having one or more openings for receiving one or more light units.

20. A lighting assembly of claim 19, wherein a width of the inner recess is sufficiently large to receive the pole radially and inwardly into the inner recess.
